(19) United States
(12) Patent Application Publication
(10) Pub. No.: US 2008/0055224 A1
(43) Pub. Date: Mar. 6, 2008

(54) ARRAY SUBSTRATE AND DISPLAY PANEL HAVING THE SAME

(75) Inventors: Seung-Hyun HUR, Cheonan-si (KR); Min-Wook PARK, Seongnam-si (KR); Young-Goo SONG, Cheonan-si (KR); Kweon-Sam HONG, Seoul (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/849,487

(22) Filed: Sep. 4, 2007

(30) Foreign Application Priority Data
Sep. 4, 2006 (KR) 10-2006-0084805

(51) Int. Cl. G09G 3/36

(52) U.S. Cl. 345/92; 345/87

(57) ABSTRACT

In an array substrate, a gate line is arranged on a base substrate and extends in a first direction, and a data line is insulated from and crossing the gate line and extends in a second direction. A switching part is connected between the gate line and the data line. A pixel electrode is connected to the switching part and partially overlaps the data line. The pixel electrode has an opening, and the opening is spaced apart from the data line in a plan view.

### CROSS-REFERENCE TO RELATED APPLICATION

This application claims priority from and the benefit of Korean Patent Application No. 10-2006-0084805, filed on Sep. 4, 2006, which is hereby incorporated by reference for all purposes as if fully set forth herein.

### BACKGROUND OF THE INVENTION

1. Field of the Invention

The present invention relates to an array substrate and a display panel including the display substrate. More particularly, the present invention relates to an array substrate that may prevent light leakage and a display panel including the array substrate.

2. Discussion of the Background

In general, a liquid crystal display includes an array substrate, an opposite substrate facing the array substrate, and a liquid crystal layer interposed between the array substrate and the opposite substrate. The array substrate includes a plurality of pixels, each of which includes a gate line, a data line, a thin film transistor, and a pixel electrode. The opposite substrate includes a common electrode facing the pixel electrode.

As compared to a cathode ray tube display apparatus, the liquid crystal display is advantageous in that it is thinner, but it also has a drawback in that it has a narrow viewing angle. Recently, in order to improve the narrow viewing angle of the liquid crystal display, patterned vertical alignment (PVA) mode liquid crystal displays and super-patterned vertical alignment (SPVA) mode liquid crystal displays, which have wider viewing angles, have been researched and developed.

In a PVA or SPVA mode liquid crystal display, the pixel electrode formed on the array substrate and the common electrode formed on the opposite substrate are patterned to have a first opening and a second opening, respectively, which are spaced apart from each other. Each pixel is divided into a plurality of domains by the first and second openings to align the liquid crystal molecules in various directions, thereby widening the viewing angle.

FIG. 1 is a view showing a position relationship between a data line and a pixel electrode and the liquid crystal alignment in accordance with the position relationship of a conventional SPVA mode liquid crystal display.

Referring to FIG. 1, a pixel electrode 10 is provided with an opening 10a formed therethrough, and liquid crystal molecules 13 are aligned in different directions with reference to the opening 10a.

When a data line 12 is formed corresponding to the opening 10a, a fringe field is formed between the pixel electrode 10 and the data line 12.

For instance, when the pixel electrode 10 in a turn-off state is maintained at 5 volts and a pixel voltage applied to the data line 12 swings between 0 and 10 volts, the fringe field is formed between the pixel electrode 10 and the data line 12 due to the electrical potential difference between the voltage of the pixel electrode 10 and the pixel voltage applied to the data line 12. As a result, the liquid crystal molecules 13 adjacent to the opening 10a are tilted abnormally, and light leakage occurs in the pixel region due to a vertical crosstalk effect.

In order to prevent light leakage, a structure such as a black matrix may be formed in a region where the opening and the data line overlap. However, when a black matrix is employed to prevent light leakage, the aperture ratio of the liquid crystal display may be lowered.

### SUMMARY OF THE INVENTION

The present invention provides an array substrate that may prevent light leakage without lowering the aperture ratio.

The present invention also provides a display panel including the array substrate.

Additional features of the invention will be set forth in the description which follows, and in part will be apparent from the description, or may be learned by practice of the invention.

The present invention discloses an array substrate including a base substrate, a gate line, a data line, a switching part, and a pixel electrode.

The gate line is arranged on the base substrate and extends in a first direction. The data line is insulated from and crosses the gate line and extends in a second direction. The switching part is connected between the gate line and the data line. The pixel electrode is connected to the switching part. The pixel electrode includes a first sub-pixel electrode partially overlapped the data line and a second sub-pixel electrode insulated from the first sub-pixel electrode and substantially spaced apart from the data line in a plan view. An opening is disposed between the first sub-pixel electrode and the second sub-pixel electrode, and is spaced apart from the data line in a plan view.

The present invention also discloses a display panel including an array substrate, an opposite substrate coupled to the array substrate, and a liquid crystal layer interposed between the array substrate and the opposite substrate.

The array substrate includes a base substrate, a gate line, a data line, a switching part, and a pixel electrode. The gate line is arranged on the base substrate and extends in a first direction, and a data line is insulated from and crosses the gate line and extends in a second direction. The switching part is connected between the gate line and the data line. The pixel electrode is connected to the switching part. The pixel electrode includes a first sub-pixel electrode partially overlapped the data line and a second sub-pixel electrode insulated from the first sub-pixel electrode and substantially spaced apart from the data line in a plan view. An opening is disposed between the first sub-pixel electrode and the second sub-pixel electrode, and is spaced apart from the data line in a plan view.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention

FIG. 1 is a view showing a position relationship between a data line and a pixel electrode and a liquid crystal alignment state in accordance with the position relationship of a conventional SPVA mode liquid crystal display;

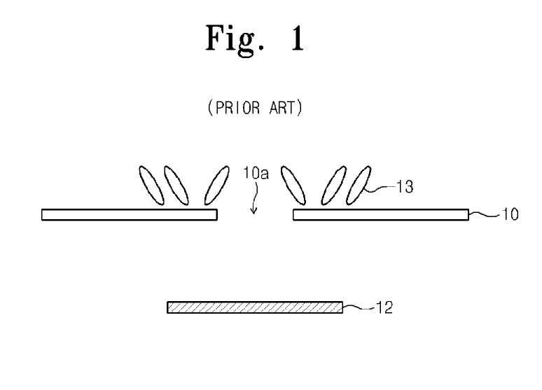

FIG. 2 is a plan view showing an array substrate according to an exemplary embodiment of the present invention.

FIG. 3 is a cross-sectional view taken along line I-I′ of FIG. 1.

FIG. 4 is a plan view showing an array substrate according to another exemplary embodiment of the present invention.

FIG. 5 is an enlarged view showing portion II of FIG. 4.

FIG. 6 is a plan view showing an array substrate according to another exemplary embodiment of the present invention.

FIG. 7 is a plan view showing a super-patterned vertical alignment mode display panel including the array substrate shown in FIG. 6 according to an exemplary embodiment of the present invention.

FIG. 8 is a cross-sectional view taken along line III-III′ of FIG. 7.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

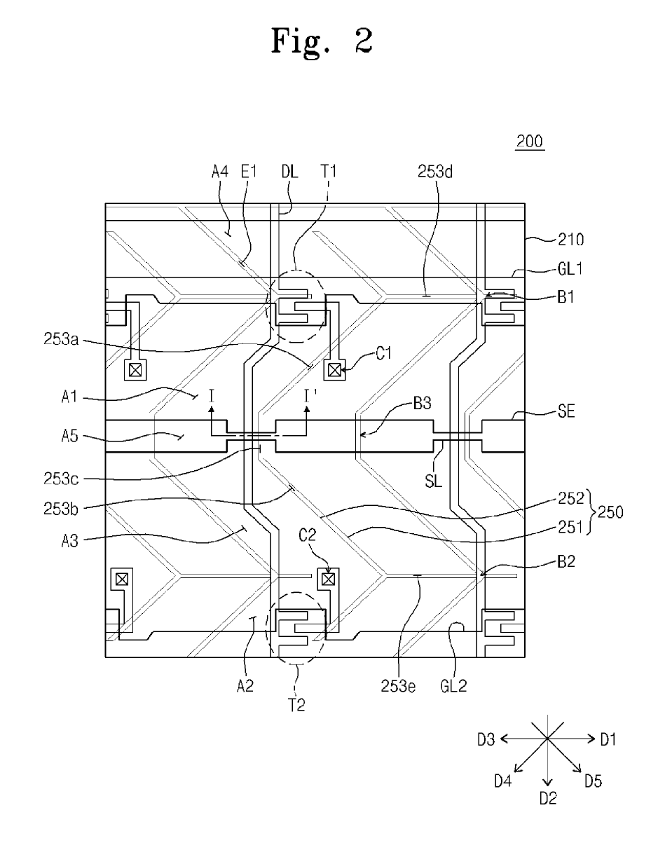

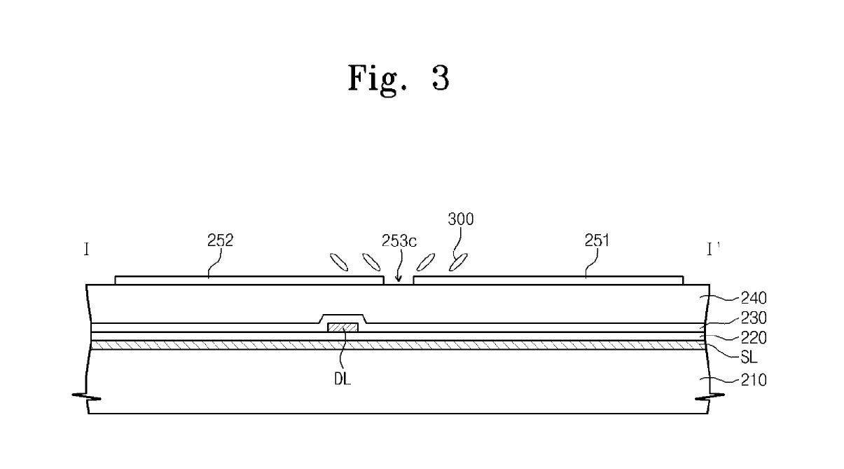

FIG. 2 is a plan view showing an array substrate according to an exemplary embodiment of the present invention, and FIG. 3 is a cross-sectional view taken along line I-I′ of FIG. 2.

Referring to FIG. 2, an array substrate 200 includes a base substrate 210 and a plurality of pixels arranged on the base substrate 210 in a matrix configuration. Each pixel includes a main gate line GL1, a sub gate line GL2, a data line DL, a first thin film transistor T1, a second thin film transistor T2, a pixel electrode 250, a storage line SL, and a storage electrode SE.

The main and sub gate lines GL1 and GL2 extend in a first direction D1 and are spaced apart from each other. The main gate line GL1 receives a first gate signal during an earlier H/2 period within a 1H period where the pixels corresponding to one row are activated, and the sub gate line GL2 receives a second gate signal during a later H/2 period within the 1H period. The first gate signal is maintained at a gate-on voltage during the earlier H/2 period and at a gate-off voltage during the later H/2 period. On the contrary, the second gate signal is maintained at the gate-off voltage during the earlier H/2 period and at the gate-on voltage during the later H/2 period.

The data line DL extends in a second direction D2 substantially perpendicular to the first direction D1. The data line DL is formed on a different layer than the main and sub gate lines GL1 and GL2, so the data line DL1 is insulated from the main and sub gate lines GL1 and GL2. The data line DL receives a high pixel voltage during the earlier H/2 period and a low pixel voltage lower than the high pixel voltage during the later H/2 period.

The pixel electrode 250 includes a main pixel electrode 251 to which the high pixel voltage is applied during the earlier H/2 period and a sub pixel electrode 252 to which the low pixel voltage is applied during the later H/2 period.

The first thin film transistor T1 is connected to the main gate line GL1 and the data line DL. Particularly, the first thin film transistor T1 includes a first gate electrode connected to the main gate line GL1, a first source electrode connected to the data line DL, and a first drain electrode connected to the main pixel electrode 251 through a first contact hole C1. Thus, the first thin film transistor T1 applies the high pixel voltage to the main pixel electrode 251 during the earlier H/2 period in response to the first gate signal.

The second thin film transistor T2 is connected to the sub gate line GL2 and the data line DL. Particularly, the second thin film transistor T2 includes a second gate electrode connected to the sub gate line GL2, a second source electrode connected to the data line DL, and a second drain electrode connected to the sub pixel electrode 252 through a second contact hole C2. Thus, the second thin film transistor T2 applies a low pixel voltage to the sub pixel electrode 252 during the later H/2 period in response to the second gate signal.

The pixel electrode 250 has a W shape rotated of about 90 degrees in a counterclockwise direction with reference to the data line DL. Particularly, the pixel electrode 250 includes a first inclined portion A1, a second inclined portion A2, a third inclined portion A3, a fourth inclined portion A4, and a straightened portion A5. The first and second inclined portions A1 and A2 are inclined in a fourth direction D4 between the second direction D2 and a third direction D3 and opposite the first direction D1, and the third and fourth inclined portions A3 and A4 are inclined in a fifth direction D5 between the first and second directions D1 and D2. The first and fourth inclined portions A1 and A4 are connected to each other to form a V shape, and the second and third inclined portions A2 and A3 are connected to each other to form a V shape. The straightened portion A5 is positioned between the first and third inclined portions A1 and A3 and is substantially parallel to the data line DL.

The pixel electrode 250 includes a first bending portion B1 defined by the first and fourth inclined portions A1 and A4, a second bending portion B2 defined by the second and third inclined portions A2 and A3, and a third bending portion B3 defined by the first and third inclined portions A1 and A3. In the present exemplary embodiment, the first bending portion B1 is arranged corresponding to the main gate line GL1, and the second and third bending portions B2 and B3 are arranged between the main and sub gate lines GL1 and GL2. The straightened portion A5 corresponds to the third bending portion B3.

The pixel electrode 250 is provided with first, second, third, fourth, and fifth openings 253a, 253b, 253c, 253d, and 253e formed therethrough. The first opening 253a is formed along the first and fourth inclined portions A1 and A4 in the V shape, and the second opening 253b is formed along the second and third inclined portions A2 and A3 in the V shape. Also, the third opening 253c is formed corresponding to the straightened portion A5 to connect the first opening 253a to the second opening 253b. As an example of the present exemplary embodiment, the first, second, and third openings 253a, 253b, and 253c are placed at a central point between two longitudinal sides of the pixel electrode 250, which are substantially parallel to each other. Also, the fourth opening 253d is formed through the first bending portion B1 of the pixel electrode 250 and is substantially parallel to the main gate line GL1. The fifth opening 253e is formed through the second bending portion B2 of the pixel electrode 250 and is substantially parallel to the sub gate line GL2.

As shown in FIG. 2 and FIG. 3, the first, second, third, fourth, and fifth openings 253a, 253b, 253c, 253d, and 253e are placed in regions that do not overlap the data line DL, so that the first, second, third, fourth, and fifth openings 253a, 253b, 253c, 253d, and 253e do not intersect the data line DL. Especially, the data line DL extends in the second direction D2 substantially parallel to the third opening 253c in a region adjacent to the third opening 253c. If the data line DL overlaps the third opening 253c, an electric field may be formed between the data line DL and the pixel electrode 250 due to the pixel voltage applied to different pixels through the data line DL. The liquid crystal molecules 300 may be tilted abnormally due to the electric field, so that the region where the data line DL overlaps the third opening 253c becomes brighter than a region adjacent thereto, thereby causing light leakage.

As described above, the first, second, third, fourth, and fifth openings 253a, 253b, 253c, 253d, and 253e are placed in regions that do not overlap the data line DL, to thereby prevent the data line DL from overlapping the third opening 253c and thereby causing light leakage between the data line DL and the third opening 253c. In the present exemplary embodiment, the distance between the data line DL and the third opening 253c may be in the range of about 0.1 micrometers to about 10 micrometers. For example, the distance may be about 3 micrometers.

Although not shown in the figures, the array substrate 200 is coupled with an opposite substrate (not shown). The opposite substrate includes a black matrix (BM) formed in a region E1 (hereinafter, referred to as BM region) between the pixel electrodes. Accordingly, although the liquid crystal molecules 300 in the region where the data line DL overlaps the BM region E1 are tilted abnormally, the black matrix of the opposite substrate may prevent light leakage through the overlapping region between the data line DL and the BM region E1. Thus, the data line DL may overlap the BM region E1.

However, when the black matrix is formed corresponding to the overlapping region between the data line DL and the first, second, third, fourth, and fifth openings 253a, 253b, 253c, 253d, and 253e, the aperture ratio of the array substrate 200 may be reduced. In the present exemplary embodiment, the first, second, third, fourth, and fifth openings 253a, 253b, 253c, 253d, and 253e are placed in regions that do not overlap the data line DL, so that light leakage may be prevented.

Referring again to FIG. 2, the main pixel electrode 251 of the pixel electrode 250 is bent in the third direction D3 to have a V shape. The sub pixel electrode 252 is defined by the remaining portion of the pixel electrode 250 and is insulated from the main pixel electrode 251 by the first, second, third, fourth, and fifth openings 253a, 253b, 253c, 253d, and 253e. Therefore, the main pixel electrode 251 has an area smaller than that of the sub pixel electrode 252.

The storage line SL extends in the first direction D1 and is placed between the main and sub gate lines GL1 and GL2. The storage electrode SE extends from the storage line SL in a rectangular shape. The storage line SL receives a common voltage and applies the common voltage to the storage electrode SE. The storage electrode SE faces the pixel electrode 250, and insulation layers, such as a gate insulation layer 220, a protection layer 230, and an organic insulation layer 240, are disposed between the storage electrode SE and the pixel electrode 250.

The storage electrode SE and the storage line SL are formed on the same layer as the main and sub gate lines GL1 and GL2, but are insulated from each other. In the present exemplary embodiment, the data line DL is insulated from the storage line SL while crossing the storage line SL. That is, when the data line DL and the storage electrode SE overlap each other, a parasitic capacitance between the data line DL and the storage electrode SE increases. Therefore, the data line DL crosses the storage line SL, which may reduce the parasitic capacitance.

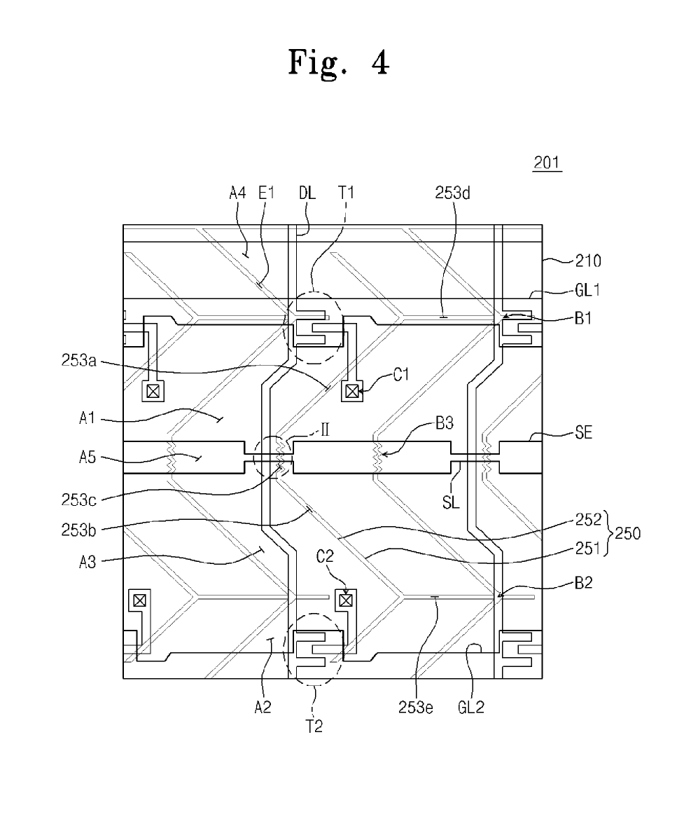

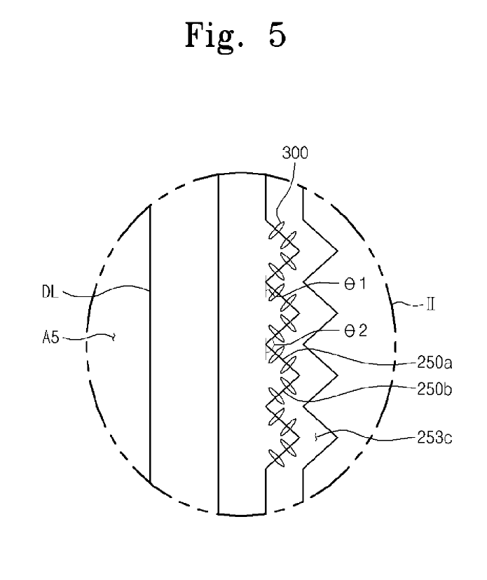

FIG. 4 is a plan view showing an array substrate according to another exemplary embodiment of the present invention, and FIG. 5 is an enlarged view showing portion II of FIG. 4. In FIG. 4, the same reference numerals denote the same elements as in FIG. 2, and thus, detailed descriptions of the same elements will be omitted.

Referring to FIG. 4, an array substrate 201 includes a pixel electrode 250 having a W shape rotated of about 90 degrees in a counterclockwise direction with reference to the data line DL.

More specifically, the pixel electrode 250 includes a first inclined portion A1, a second inclined portion A2, a third inclined portion A3, a fourth inclined portion A4, and a straightened portion A5. The first and fourth inclined portions A1 and A4 are connected to each other in a V shape, and the second and third inclined portions A2 and A3 are connected to each other in the V shape. The straightened portion A5 is positioned between the first and third inclined portions A1 and A3 and is substantially parallel to the data line DL.

The pixel electrode 250 includes a first bending portion B1 defined by the first and fourth inclined portions A1 and A4, a second bending portion B2 defined by the second and third inclined portions A2 and A3, and a third bending portion B3 defined by the first and third inclined portions A1 and A3.

The pixel electrode 250 is provided with first, second, third, fourth, and fifth openings 253a, 253b, 253c, 253d, and 253e formed therethrough. The first opening 253a is formed along the first and fourth inclined portions A1 and A4 formed in the V shape, and the second opening 253b is formed along the second and third inclined portions A2 and A3 formed in the V shape. Also, the third opening 253c is formed corresponding to the straightened portion A5 to connect the first opening 253a to the second opening 253b. The fourth opening 253d is formed through the first bending portion B1 of the pixel electrode 250 and is substantially parallel to the main gate line GL1. The fifth opening 253e is formed through the second bending portion B2 of the pixel electrode 250 and is substantially parallel to the sub gate line GL2.

The first, second, third, fourth, and fifth openings 253a, 253b, 253c, 253d, and 253e are placed in regions that do not overlap the data line DL, and the first, second, third, fourth, and fifth openings 253a, 253b, 253c, 253d, and 253e do not intersect the data line DL, thereby preventing light leakage.

The straightened portion A5 is substantially parallel to the data line DL in the third bending portion B3. As an example of the present invention, outer sides of the straightened portion A5 and inner sides of the straightened portion A5, which define the third opening portion 253c, have a saw-tooth shape.

As shown in FIG. 5, each inner side of the straightened portion A5 includes a plurality of first inclined sides 250a inclined at a first angle θ1 with respect to the data line DL and a plurality of second inclined sides 250b inclined at a second angle θ2 with respect to the data line DL. In the present exemplary embodiment, the first angle θ1 is about 45 degrees and the second angle θ2 is about 135 degrees.

As the above-described, since the outer and inner sides have the saw-tooth shape, the liquid crystal molecules 300 are tilted at about 45 degrees in the regions adjacent to the first inclined sides 250a and tilted at about 135 degrees in the regions adjacent to the second inclined sides 250b, which may prevent deterioration of brightness due to textures.

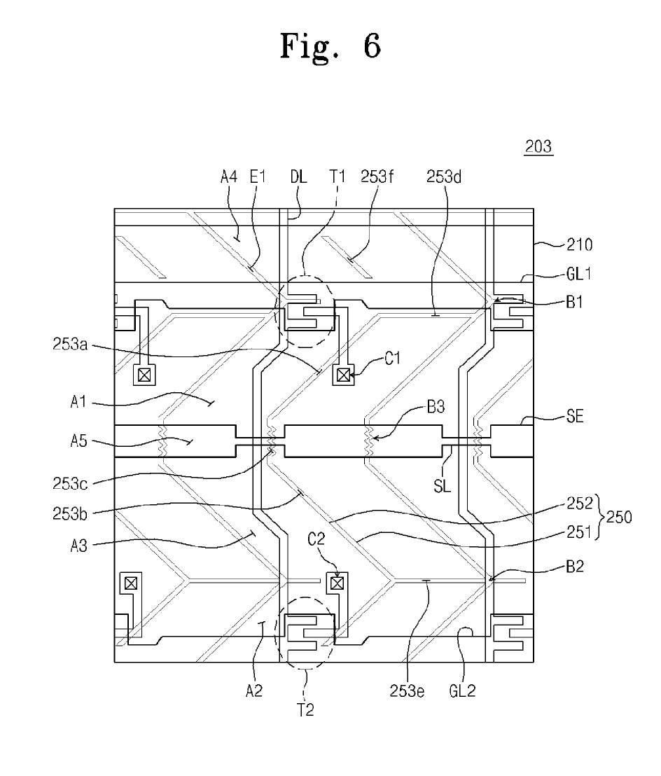

FIG. 6 is a plan view showing an array substrate according to another exemplary embodiment of the present invention. In FIG. 6, the same reference numerals denote the same elements in FIG. 4, and thus detailed descriptions of the same elements will be omitted.

Referring to FIG. 6, an array substrate 203 includes a pixel electrode 250 having a W shape rotated of about 90 degrees in a counterclockwise direction with reference to the data line DL. The pixel electrode 250 includes a first inclined portion A1, a second inclined portion A2, a third inclined portion A3, a fourth inclined portion A4, and a straightened portion A5. The first and fourth inclined portions A1 and A4 are connected to each other in a V shape, and the second and third inclined portions A2 and A3 are connected to each other in the V shape. The straightened portion A5 is positioned between the first and third inclined portions A1 and A3 and is substantially parallel to the data line DL.

The pixel electrode 250 includes a first bending portion B1 defined by the first and fourth inclined portions A1 and A4, a second bending portion B2 defined by the second and third inclined portions A2 and A3, and a third bending portion B3 defined by the first and third inclined portions A1 and A3.

The pixel electrode 250 is provided with first, second, third, fourth, fifth, and sixth openings 253a, 253b, 253c, 253d, 253e, and 253f formed therethrough. The first opening 253a is formed along the first inclined portion A1, and the second opening 253b is formed along the second and third inclined portions A2 and A3 in the V shape. Also, the third opening 253c is formed corresponding to the straightened portion A5 to connect the first opening 253a to the second opening 253b. The fourth opening 253d is adjacent to and substantially parallel to the main gate line GL1. The fifth opening 253e is formed through the second bending portion B2 of the pixel electrode 250 and is substantially parallel to the sub gate line GL2. The sixth opening 253f is formed along the fourth inclined portion A4.

The third opening 253c is placed in a region that does not overlap the data line DL, and the first, fourth, and sixth openings 253a, 253d, and 253f are placed in regions that do not overlap the main gate line GL1. Also, the second opening 253b is placed in a region that does not overlap the sub gate line GL2. As described above, the first, second, third, fourth, fifth, and sixth openings 253a, 253b, 253c, 253d, 253e, and 253f are placed in regions that do not overlap the data line DL, the main gate line GL1, and the sub gate line GL2, so that light leakage may be prevented.

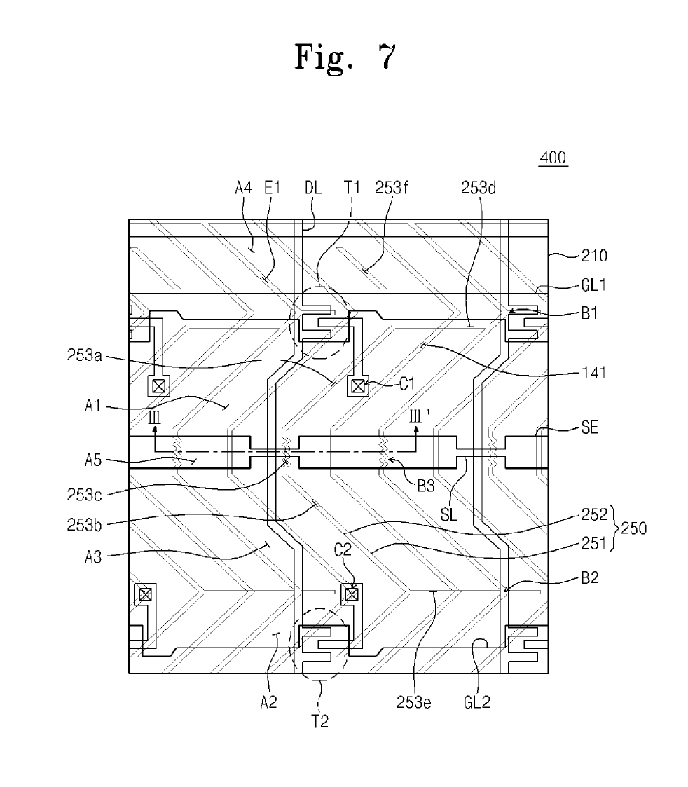

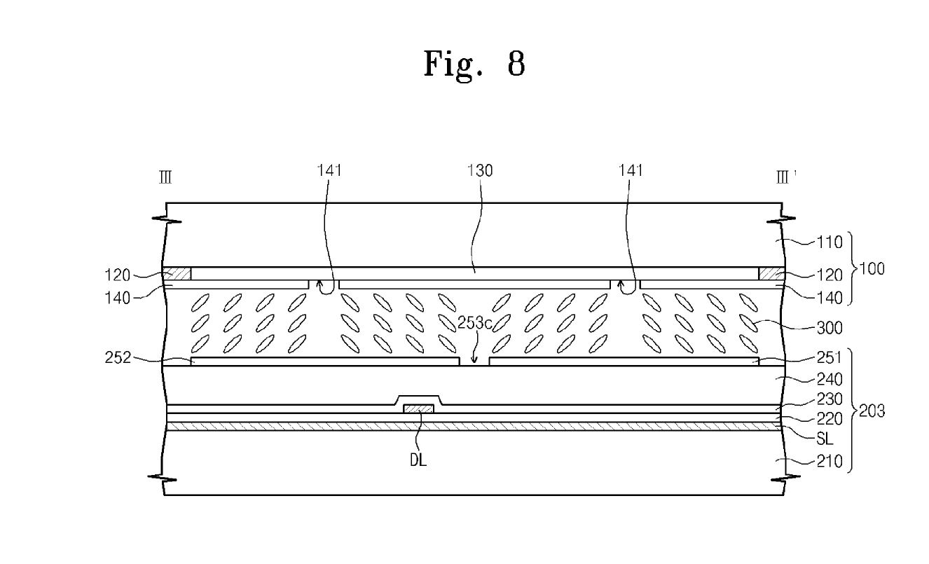

FIG. 7 is a plan view showing a super-patterned vertical alignment mode display panel having the array substrate shown in FIG. 6 according to an exemplary embodiment of the present invention, and FIG. 8 is a cross-sectional view taken along line III-III′ of FIG. 7. In FIG. 7, the same reference numerals denote the same elements as in FIG. 6, and thus, detailed descriptions of the same elements will be omitted.

Referring to FIG. 7 and FIG. 8, a super-patterned vertical alignment (SPVA) mode display panel 400 includes an array substrate 203, an opposite substrate 100 facing the array substrate 203, and a liquid crystal layer 300 interposed between the opposite substrate 100 and the array substrate 203.

The opposite substrate 100 includes a substrate 110, a black matrix 120, a color filter layer 130, and a common electrode 140. The color filter layer 130 includes red, green, and blue color pixels that are in a one-to-one correspondence relationship with the pixels, and the color filter layer 130 is arranged on the substrate 110. The black matrix 120 is disposed between the red, green, and blue color pixels to prevent light leakage from between the pixels.

The common electrode 140 is formed uniformly on the black matrix 120 and the color filter layer 130. As an example of the present exemplary embodiment, the common electrode may be indium tin oxide (ITO) or indium zinc oxide (IZO). The common electrode 140 is provided with a plurality of seventh openings 141 through which the color filter layer 130 is partially exposed.

The first, second, third, and sixth openings 253a, 253b, 253c, and 253f are placed in regions corresponding to an intermediate region between two adjacent seventh openings 141. Thus, multi-domains where the liquid crystal molecules of the liquid crystal layer 300 are aligned in different directions are defined in one pixel region.

Especially, in case of the SPVA mode display panel 400 where the pixel electrode 250 arranged on the array substrate 203 is divided into the main and sub pixel electrodes 251 and 252, one pixel region may be divided into eight domains. Accordingly, a voltage may be applied to four domains corresponding to the main pixel electrode 251 in order to allow the four domains to have a first gamma characteristic, and another voltage may be applied to remaining four domains corresponding to the sub pixel electrode 252 in order to allow the remaining four domains to have a second gamma characteristic. That is, different voltages may be applied to the main and sub pixel electrodes 251 and 252, respectively, so that the brightness may be compensated separately for each domain. As a result, the SPVA mode display panel 400 may improve the side viewing angle and visibility thereof.

Although not shown in figures, in a patterned vertical alignment (PVA) mode display panel, the openings formed through the pixel electrode may be placed in regions that do not overlap the data line. Thus, light leakage of the PVA mode display panel may also be prevented.

According to the array substrate and the display panel having the array substrate, the openings formed through the pixel electrode are placed in regions that do not overlap the gate line or the data line. Consequently, light leakage in the overlapping regions between the openings and the gate line or between the openings and the data line may be prevented.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An array substrate, comprising:
a base substrate;
a gate line arranged on the base substrate and extending in a first direction;
a data line insulated from and crossing the gate line and extending in a second direction;
a switching part connected between the gate line and the data line; and
a pixel electrode connected to the switching part,
the pixel electrode comprising;
a first sub-pixel electrode partially overlapped the data line; and
a second sub-pixel electrode insulated from the first sub-pixel electrode and substantially spaced apart from the data line in a plan view, and
wherein an opening is disposed between the first sub-pixel electrode and the second sub-pixel electrode, and is spaced apart from the data line in a plan view.

2. The array substrate of claim 1, wherein the pixel electrode comprises:
at least one inclined portion not parallel to the data line; and
a straightened portion substantially parallel to the data line.

3. The array substrate of claim 2, wherein a portion of the opening corresponding to the straightened portion is substantially parallel to the data line.

4. The array substrate of claim 3, wherein the distance between the portion of the opening corresponding to the straightened portion and the data line is in the range of about 0.1 micrometers to about 10 micrometers.

5. The array substrate of claim 3, wherein the pixel electrode has a W shape rotated about 90 degrees in a counterclockwise direction with reference to the data line and further comprises:
a first bending portion,
a second bending portion, and
a third bending portion,
wherein the first bending portion and the second bending portion are bent in the first direction, and the third bending portion is disposed between the first bending portion and the second bending portion and bent in a third direction opposite the first direction.

6. The array substrate of claim 5, wherein the third bending portion comprises the straightened portion.

7. The array substrate of claim 3, wherein outer sides of the straightened portion and inner sides of the straightened portion, which define the portion of the opening corresponding to the straightened portion, have a saw-tooth shape.

8. The array substrate of claim 7, wherein each of the outer sides and inner sides comprises:
a plurality of first inclined sides each inclined about 45 degrees with respect to the data line; and
a plurality of second inclined sides each inclined about 135 degrees with respect to the data line.

9. The array substrate of claim 1, wherein the opening comprises:
at least one first opening inclined with respect to the data line and extending in the inclined direction; and
at least one second opening extending in the first direction.

10. The array substrate of claim 9, wherein the second opening is spaced apart from the gate line.

11. The array substrate of claim 1, wherein the first sub-pixel electrode receives a first pixel voltage, and the second sub-pixel electrode is bent in a third direction opposite to the first direction to have a V shape and receives a second pixel voltage higher than the first pixel voltage.

12. The array substrate of claim 11, wherein the gate line comprises:
a main gate line to receive a first gate signal during an earlier H/2 period within an 1H period where pixels corresponding to a row are activated; and
a sub gate line to receive a second gate signal during a later H/2 period within the 1H period.

13. The array substrate of claim 12, wherein the switching part comprises:
a first thin film transistor connected to the data line and the main gate line to output the second pixel voltage applied to the data line to the second pixel electrode during the earlier H/2 period in response to the first gate signal; and
a second thin film transistor connected to the sub gate line and the data line to output the first pixel voltage applied to the data line to the first pixel electrode during the later H/2 period in response to the second gate signal.

14. The array substrate of claim 1, further comprising:
a storage line arranged on the base substrate and extending in the first direction substantially parallel to the gate line; and
a storage electrode partially extending from the storage line and facing the pixel electrode, and
wherein the data line is insulated from and crosses the storage line.

15. A display panel, comprising:
an array substrate;
an opposite substrate coupled to the array substrate; and
a liquid crystal layer interposed between the array substrate and the opposite substrate,
the array substrate comprising:
a base substrate;
a gate line arranged on the base substrate and extending in a first direction;
a data line insulated from and crossing the gate line and extending in a second direction;
a switching part connected between the gate line and the data line; and
a pixel electrode connected to the switching part,
the pixel electrode comprising;
a first sub-pixel electrode partially overlapped the data line; and
a second sub-pixel electrode insulated from the first sub-pixel electrode and substantially spaced apart from the data line in a plan view, and
wherein an opening is disposed between the first sub-pixel electrode and the second sub-pixel electrode, and is spaced apart from the data line in a plan view.

16. The display panel of claim 15, wherein the pixel electrode comprises at least one inclined portion not parallel to the data line and a straightened portion substantially parallel to the data line.

17. The display panel of claim 16, wherein a portion of the first opening corresponding to the straightened portion is substantially parallel to the data line.

18. The display panel of claim 17, wherein the distance between the portion of the first opening corresponding to the straightened portion and the data line is in the range of about 0.1 micrometers to about 10 micrometers.

19. The display panel of claim 17, wherein outer sides of the straightened portion and inner sides of the straightened portion, which define the portion of the first opening corresponding to the straightened portion, have a saw-tooth shape.

20. The display panel of claim 15, wherein the first opening comprises:
at least one first sub opening inclined with respect to the data line and extending in the inclined direction; and
at least one second sub opening extending in the first direction.

21. The display panel of claim 20, wherein the second sub opening is spaced apart from the gate line.

22. The display panel of claim 15, wherein the opposite substrate comprises a common electrode facing the pixel electrode, the common electrode has a plurality of second openings, and the second openings are placed at different positions than the first opening.

23. The display panel of claim 22, wherein the first opening is placed between two adjacent second openings among the second openings.
